(19) United States
(12) Patent Application Publication
(10) Pub. No.: US 2009/0078209 A1
(43) Pub. Date: Mar. 26, 2009

(54) Feeding System and Methods Relating to Feeding of Livestock

(76) Inventor: Matthew Kroeker, Winnipeg (CA)

Correspondence Address: ADE & COMPANY INC., 2157 Henderson Highway, WINNIPEG, MB, R2G1P9, CA

(21) Appl. No.: 12/233,717

(22) Filed: Sep. 19, 2008

Related U.S. Application Data
(60) Provisional application No. 60/974,174, filed on Sep. 21, 2007.

(51) Int. Cl. A01K 39/01; A01K 1/10; A01K 5/00

(52) U.S. Cl. 119/52.1; 119/51.01

(57) ABSTRACT

Feeding systems and methods relating to feeding of livestock use illumination to attract the livestock to feed.

This application claims the benefit under 35 U.S.C. 119(e) of U.S. provisional application Ser. No. 60/974,174, filed Sep. 21, 2007.

This invention relates to feeding systems and methods relating to feeding of livestock, and more particularly to feeding systems and methods using light to attract livestock to feed to increase feed consumption.

### BACKGROUND OF THE INVENTION

In agriculture it is desirable to increase the growth rate of livestock raised for meat, such as poultry, cattle or swine, so as to minimize the time it takes for the livestock to reach a suitable weight for distribution to market. It therefore may be advantageous for a farmer to encourage an increase in the rate at which livestock feed to encourage faster growth of the livestock, provided of course that the increased income from the reduced time-to-market exceeds the increase in the cost of the feed supply.

It is therefore desirable to develop methods and apparatuses for feeding livestock that will increase the rate of livestock feed consumption to decrease growth times.

### SUMMARY OF THE INVENTION

According to a first aspect of the invention there is provided a method of feeding livestock, the method comprising:

providing an amount of feed at a feeding location accessible by the livestock; and

directing illumination from a light source toward the feeding location accessible by the livestock to attract attention of the livestock to the feed.

The foregoing and following methods uses directed light to attract livestock, especially poultry, to food and/or water and encourage them to eat and drink more. Barn raised poultry, particularly turkeys, are notorious for being attracted to, pecking, and eating anything that light, especially sunlight, shines on with sufficient brightness to contrast normal house lighting. Such behaviour can be harnessed to encourage the poultry or other livestock to eat more and gain weight faster, saving time raising the birds or livestock to market weight. It has been observed that some other animals are attracted to bright, shiny or well-lit objects having a relatively high level of light-contrast with their surroundings. For example, pets, such as cats and dogs, will often chase the spot of light produced by the beam of a laser pointer. On this basis, and without being limited to any particular theory or hypothesis, it is hypothesized that livestock other than poultry may similarly be attracted to feed exposed to high-contrast illumination and may consume more feed based on this attraction.

Preferably the step of providing an amount of feed comprises providing the amount of feed in an environment darker than the illumination to create contrast therebetween.

The step of directing the illumination may comprise directing the illumination over only a fraction of the amount of feed.

The step of directing the illumination may comprise supporting the light source at an elevation above the amount of feed.

The step of directing the illumination may comprise directing a beam of light toward the feeding location. Alternatively, the step of directing the illumination may comprise exposing a strip of light, or narrow band of illumination, between the light source and the amount of feed.

The step of directing the illumination may comprise directing the illumination onto the amount of feed.

The step of directing the illumination may comprise supporting the light source on the amount of feed. Alternatively, the step of directing the illumination comprises supporting the light source within the amount of feed.

The step of directing the illumination may comprise supporting an annular light source to extend about a central portion of the amount of feed.

The step of directing the illumination may comprise directing light from outside the environment thereinto toward the feeding location.

Preferably the step of providing the amount of feed comprises operating the delivery mechanism of a poultry feeding system to supply feed to a plurality of feeding stations thereof and the step of directing the illumination comprises directing the illumination to the plurality of feeding stations.

According to a second aspect of the invention there is provided a method of increasing feed consumption at a feeding location by livestock, the method comprising directing light from a light source to provide illumination at the feeding location to attract attention of the livestock to the feeding location.

According to a third aspect of the invention there is provided a method of increasing feed consumption at a feeding location by livestock, the method comprising directing light from a light source to provide illumination at the feeding location that contrasts with environment surrounding the feeding location to attract attention of the livestock to the feeding location.

According to a fourth aspect of the invention there is provided a method of attracting livestock to a feeding location, the method comprising directing light from a light source to provide illumination at a feeding location that contrasts with environment surrounding the feeding location.

According to a fifth aspect of the invention there is provided a method of increasing feed consumption by livestock at a feeding location containing an amount of visible feed, the method comprising attracting attention of the livestock to the feeding location by illuminating only a fraction of the visible feed to provide visible contrast between the fraction of the visible feed and a remainder of the visible feed.

According to a sixth aspect of the invention there is provided a method of attracting livestock to a feeding location containing visible feed, the method comprising illuminating only a fraction of the visible feed to provide visible contrast between the fraction of the visible feed and a remainder of the visible feed.

According to a seventh aspect of the invention there is provided a feeding system for livestock, the feeding system comprising:

a feeding station comprising a feed holder arranged for supporting feed in a position accessible by the livestock; and

a light source arranged for mounting at a position relative to the feeding station to illuminate the feed holder.

The light source may comprise a laser, a light-emitting diode, a fibre optic light source or other light source.

The light source may comprise an annular light source arranged for extending about an axis of the feed container.

The light source may be arranged for support above a bottom of the feed holder.

The light source may be arranged for support on the feeding station above the bottom of the feed holder.

The light source may be arranged for support on a drop tube or feeder cone arranged to depend downward toward the bottom of feed holder to supply the feed thereto. Alternatively the light source may be supported on an anti-scratch ring arranged to extend around a drop tube arranged to depend downward toward the bottom of feed holder to supply the feed thereto.

There may be provided a feed delivery line coupled between a feed supply container and the feeding station to facilitate delivery of feed thereto, with the light source arranged for support on the feed delivery line.

The feed holder may comprise a feed pan having an outer annular wall, the light source being arranged for support inward of the outer annular wall.

The light source may be arranged for mounting at an inner surface of the outer annular wall. Alternatively, the light source may be mounted at an outer surface of a feeder cone depending downward into the feed pan within the outer annular wall.

The light source may comprise a fibre optic cable arranged to extend into the feeding station to lay along the feed holder.

### BRIEF DESCRIPTION OF THE DRAWINGS

In the accompanying drawings, which illustrate exemplary embodiments of the present invention:

FIG. 1 is a side elevational view of a prior art turkey feeder with a feed pan thereof cut away for illustration.

FIG. 2 is a partial cross sectional view of a first embodiment turkey feeder according to the present invention with its feed pan and feeder cone partially cut away to schematically illustrate a light ring mounted on an exterior of the feeder cone.

FIG. 3 is a partial cross sectional view of a second embodiment turkey feeder according to the present invention with its feed pan and feeder cone partially cut away to schematically illustrate a light ring integrated into the feeder cone.

FIG. 4 is a partial cross sectional view of a third embodiment turkey feeder according to the present invention with its feed pan and feeder cone partially cut away to schematically illustrate a light ring integrated into the feed pan.

FIG. 5 is a partial cross sectional view of a fourth embodiment turkey feeder according to the present invention with its feed pan cut away to schematically illustrate fibre optic cables extending through its feeder cone into the feed pan.

FIG. 6 is a perspective view of a fifth embodiment turkey feeder according to the present invention featuring laser lights hung from its grill bars to point downward into its feed pan.

FIG. 7 is a perspective view of a sixth embodiment turkey feeder according to the present invention featuring a ring of light-emitting diodes (LEDs) mounted on an anti-scratch ring positioned within its feed pan.

### DETAILED DESCRIPTION

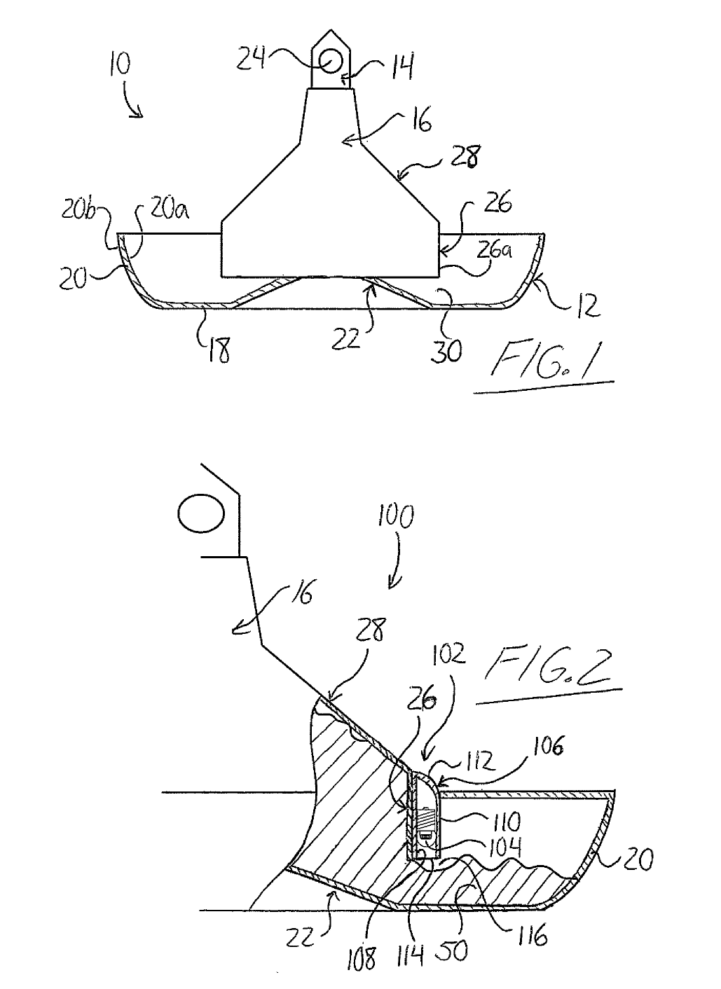

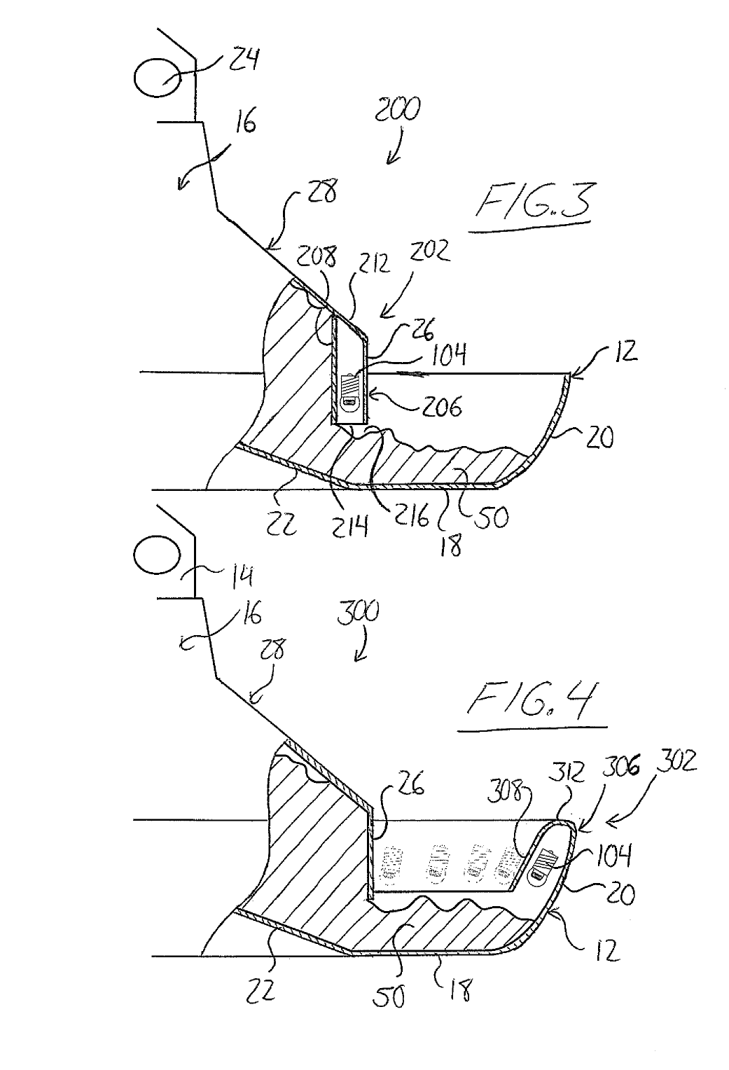

FIG. 1 shows a prior art poultry feeder of a grill-less type, examples of which are available from Chore-Time® Poultry Productions Systems. The feeder 10 features a feed pan 12, a drop tube 14 depending downward toward the bottom of the feed pan 12 and a feeder cone 16 integral with and extending downward from the drop tube 14. The feed pan 12 has an annular base panel 18 from outer edges of which an annular outer wall 20 curves upward with a concave inner surface 20a of the wall facing inward toward the center of the feeder and a convex outer surface 20b of the wall facing outward from the feeder. At the inner edge of the annular base panel 18, the bottom of the feed pan 12 extends obliquely upward to an apex at the center of the feeder 10, defining a conical dome 22 at the center of the feed pan 12 so that feed falling into the pan 12 through the drop tube 14 will tend to disburse outward from the apex of the dome 22 under gravity toward the outer annular wall 20 along the base panel 18 where it is easily accessible by poultry. The upper end of the drop tube 14 is fitted about a feed delivery line (not shown) so that the line passes through an opening 24 in the upper end of the drop tube 14 so communicate the hollow interior of the drop tube 14 with an opening in the bottom of the auger-equipped delivery line. The delivery line is connected at one end to a feed supply container from which feed is delivered to multiple feeders disposed along the length of the delivery line. The feed from the delivery line flows down through the drop tube 14 into the feed pan 12. The position of a vertical annular wall 26 at the bottom of the feeder cone 16 at the bottom end of a frustoconical portion 28 thereof projecting downward and outward from its connection to the integral drop tube 14 communicating with its open top end controls flow of the feed outward from the feeder cone through its open bottom toward the outer annular wall 20 of the feed pan 12 by defining height of an open space 30 between the vertical annular wall 16a and the bottom of the feed pan 12. FIGS. 2 to 5 show embodiments of the present invention based on modifications to prior art feeders of this type.

FIG. 2 shows a first embodiment feeder 100 of similar structure to the prior art feeder 10 of FIG. 1, but with a ring-defining light system 102 extending fully about the feeder cone 16 at the vertical annular wall 26 at the bottom thereof. Light system 102 features a plurality of light sources 104, illustrated schematically in the figures by incandescent bulbs, supported at spaced positions about the feeder cone 16 to illuminate a portion of the feed 50 that lies on the annular plate 18 defining the bottom of the feed pan 12 between the curved annular outer wall 20 thereof and the conical dome 22. The light sources 104 are spaced about the feeder cone 16 in such a way as to provide illumination that is visible from all sides of the round feeder 100 to draw the attention of poultry regardless of their positions relative to the feeder. Light system 102 features a shroud 106 having an inverted U-shaped cross section with an inner leg 108 mounted against the outer surface 26a of the vertical annular wall 26 of the feeder cone 16, and outer leg 110 spaced outwardly from the inner leg and an upper central portion 112 connecting the two legs overtop the light sources 104 to close the top of the shroud 106. The shroud 106, being open only at its bottom end 114 and having the legs of its cross section depend downward past the light sources 104, is opaque so as to basically limit the emission of light from the light sources 104 to a downward direction onto a fraction of the feed visible to the poultry between the curved annular wall 20 and the conical dome 22 of the feed pan. Light system 102 may be sold as an add-on for an existing feeder, for example securable by adhesive between the outer surface 26a of the vertical annular wall 26 and inner wall 108 of the shroud 106 or by other known fastening methods. The inner wall 108 of the shroud 106 may be eliminated, instead attaching the upper portion 112 atop the frustoconical portion 28 of the feeder cone 16 and using the existing vertical annular wall 26 of the feeder cone to complete the direction-limiting enclosure of the light sources on three of their four sides in the illustrated cross section.

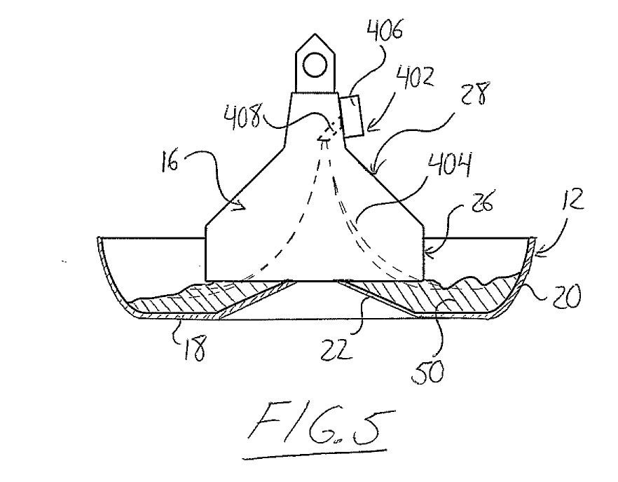

FIG. 3 shows a second embodiment feeder 200 having a final structure similar to that of the first embodiment shown in FIG. 2, but with a ring-defining light system 202 incorporated as part of the feeder 200 rather than provided as an-add on for use therewith. Here light system 202 is defined inward of the vertical annular wall 26 of the feeder cone 16, rather than on the outside surface thereof between the feeder cone 16 and the curved outer wall 20 of the feeder pan 12. Here, the generally u-shaped cross-section of the shroud 206 features an outer leg defined by the vertical annular wall 26 of the feeder cone, an inner leg 208 defined by a second vertical annular wall depending downward from the frustoconical portion 28 of the feeder cone 16 at a distance radially inward from the first vertical annular wall 26 and a central portion 212 defined by an end segment of the frustoconical portion 28 of the feeder cone 16 obliquely connecting the parallel vertical annular walls. Light sources 104 are again spaced about the central axis of the feeder (defined by the common central axes of the concentric drop tube 14, feeder cone 16 and feed pan 12), wired together for electronic operation and mounted within the shroud 206 between the inner and outer walls of the shroud (i.e. between the inner and outer legs of the shroud's generally u-shaped cross section as shown in the figures), so as to direct illumination directly downward to the feed disposed closely below the open bottom end 214 of the shroud 206 to create a narrow strip or band of visible light in the space 216 between the first vertical annular wall 26 supported at the end of the frustoconical section 28 of the feeder cone and the feed 50 in the feed pan 12. If the feeder cones and feed pans of the first and second embodiment are considered to be of the same shape and size, ring-defining light system 202 illuminates an annular portion of the visible feed just inward of the illumination provided in the first embodiment over the transitioning portion of the bottom of the feed pan 12 between the annular base plate 18 and the dome 22.

With the vertical annular wall 26 of the feed cone 16 and the inner annular leg 208 of the shroud disposed depending downward to generally the same elevation over the area of transition between the dome 22 and annular plate 18 of the feeder below the feeder cone 16 to control the height, and thus the amount, of feed that will flow outward past them, only a narrow strip of light will be visible to the poultry in the small space 216 between the bottom end 214 of the shroud 206 and the feed 50 therebelow. Limiting the passage of light this way in a single downward direction over a relatively small radial expanse of the feed 50 provides an intense lighting effect at the annular portion of the feed proximate the feeder cone 16, providing a high-degree of contrast with the surrounding environment of a dimly lit poultry barn so as to attract the visual attention of the poultry to promote pecking at the feed 50.

FIG. 4 shows a third embodiment feeder 300 again featuring a ring-defining light system 302, but formed at the outer annular wall 20 of the feed pan 12 rather than at the outer annular wall 26 of the feeder cone 16. At the top or rim 312 of the feed pan 12, the curved annular wall 20 of the pan bends back over itself inward toward the middle of the feeder 300 to define the another shroud 306 of generally U-shaped cross section having an open bottom end 314. An inner leg 308 of this shroud 306 is defined by the portion of the pan 12 depending downward into the pan's interior within the annular outer wall 20 from the bent rim 312 at the top end of the outer annular wall 20, the open bottom end 314 being defined by the bottom end of the inner annular wall 308 of the pan 12 (or the inner leg of the U-shaped cross section). Again the shroud's U-shaped cross section directs illumination downward onto an annular portion of the feed 50, which in this embodiment is located immediately adjacent the outer annular wall 20 of the feed pan 12, creating a thin visible strip of high contrast light in the open space between the bottom end of the shroud 306 and the feed 50 disposed therebeneath. The bottom end of the inner leg 308 of the shroud's cross section does not extend sufficiently far into the pan so as to project past the level of feed typically experienced during normal operation of the feeder, to ensure that the feed does not block view of the light during normal operation of the feeder. If the density of particulate feed and the brightness of the light sources are such that light is visible through some levels of feed, the particular positioning of the lower end of the inner annular wall 308 of the folded feed pan 12 over expected feed levels may not be critical.

The ring-defining annular light systems of the embodiments described above need not necessarily rely on multiple incandescent bulbs, as, for example, multiple LEDs or neon or fluorescent bulbs can similarly be individually mounted at spaced positions about the center of the feeder, a flexible LED tube can be wrapped about the center of the feeder or a single fluorescent or neon ring tube may be extended about the center of the feeder. The annular light systems also need not necessarily be shrouded, although limiting exposure of the light to a direction aimed toward only the feed helps ensure that any attention paid by the animal to the illumination is focused on the feed, thereby contributing to the purpose of encouraging the animal to consume feed from the feeder. It should also be appreciated that the light sources spaced about he center of the feeder and the center portion of the feed therein need not necessarily be provided as a continuous closed-ring structure, as the system may alternatively be divided into separate sections spaced about the central axis of the feeder.

Although the second and third embodiment feeders show the light systems thereof as integral parts, they may instead be add-on structures similar to that of the first embodiment for on-site installation on existing feeders For example, the second embodiment light structure may be provided as a shrouded structure similar to that of the first embodiment but with adhesive or fasteners provided on the outermost wall (defined by the outer leg of the U-shaped cross-section) for securing to the inner surface of the feeder cones vertical annular wall 26, rather than on the inner wall for securing to the outer surface of the vertical annular wall 26. As another example, the third embodiment integral light structure at the rim of the feed pan atop the outer annular wall 20 thereof may be replaced with an add-on light system having a shroud similar to the first and second embodiments, with adhesive on the outer wall of the shroud to affix to the inner surface of the pan's annular wall 20 or with fasteners for securing to the pan's outer wall, such as hooks extending outward from the shroud to bend over the top end of the pan's annular wall 20 to hang the light system from the pan's rim or clips arranged to clip the light system thereon.

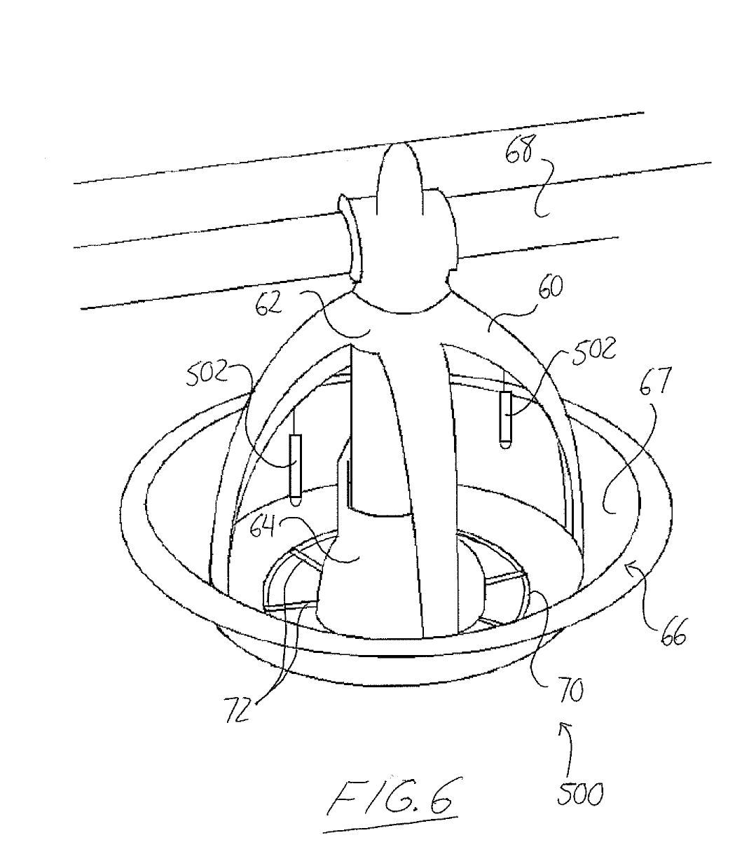

FIG. 5 shows a fourth embodiment feeder 400 having a structure very similar to the prior art feeder 10 of FIG. 1, but with a fibre optic light system 402 arranged to extend light-carrying fibre optic cables 404 into the feed pan 12 to provide high contrast illumination on or within the feed to attract the attention of poultry to feed 50 within the feed pan 12. As shown, the fibre optic light system 402 comprises an illuminator 406 mounted on a neck of the feed cone 16 proximate the top end thereof above the frustoconical portion 28 and fibre optic ports 408 connecting the illuminator 406 to the fibre optic cables 404 through a hole in the neck of the feed cone 16. The fibre optic cables depend from the illuminator downward in the interior of the hollow feeder cone, past the open bottom thereof and into the feed pan 12 in the same space between the bottom of the feed pan 12 and the bottom of the feeder cone 16 through which the feed 50 passes. The fibre optic cables transfer light from the illuminator into or onto the feed 50 and may be end-emitting or side-emitting type fibre cables, emitting light from their ends or sides accordingly. The fibre optic system may be replaced with other flexible light sources, such as a flexible LED tube positioned to extend at least partially within the feed pan.

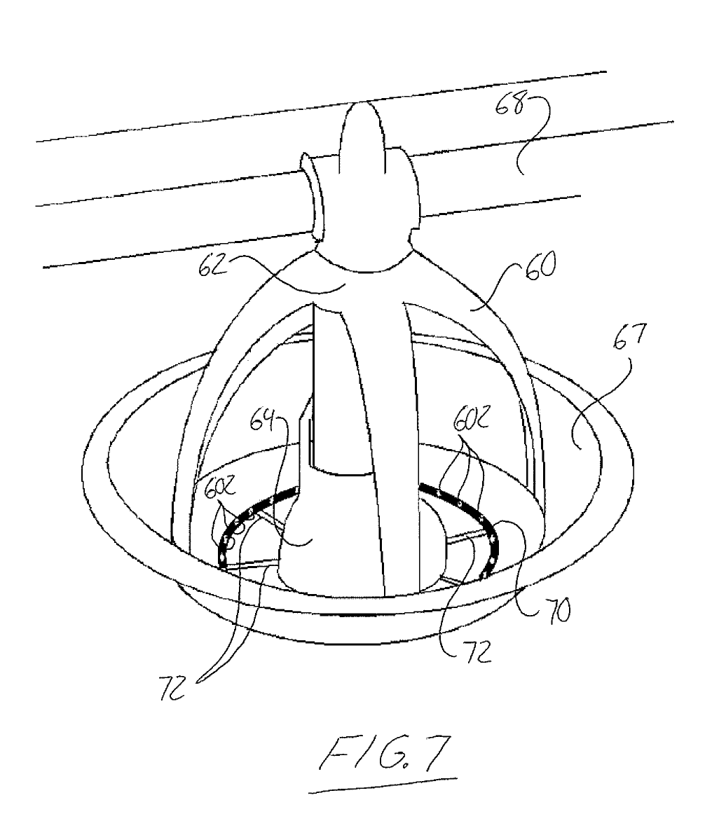

FIGS. 6 and 7 show fifth and sixth embodiment feeders sharing features with prior art grill-equipped feeders, such as the Tru Pan feeder available from Big Dutchman, in which a plurality of arms 60 depend outward and downward from a rim 62 extending around the drop tube into the feed pan 66 at circumferentially spaced points about the rim 62 to limit entry to the feed pan 66. Similar to the other prior art feeder type described above, the feed pan 66 has an outer annular wall 67 and a conical dome at its peripheral edge and center respectively and the top end of the drop tube is adapted to connection to an auger-equipped feed delivery line 68 that delivers feed to the feeder from a supply container or hopper, with the tubular drop tube communicating with an opening in the bottom of the delivery line 68 to direct feed therefrom into the feed pan 66. A feeder cone 64 is integral with the bottom end of the drop tube, to depend downward and flare radially outward therefrom toward the bottom of the feed pan to define an annular wall for controlling flow of feed from the drop tube into the feed pan like the feeder cone of FIGS. 1 to 5. An anti-scratch ring 70 is supported concentrically about the feeder cone 64 at a radial distance outward from the annular wall thereof by a plurality of ribs 72 projecting radially outward therefrom at positions spaced circumferentially thereabout. As feed from the delivery line 68 enters the feed pan 66 through space left between the bottom of the feeder cone 64 and the bottom of the feed pan 66, the anti-scratch ring 70 is thus supported at an elevated distance over the bottom of the feed pan onto which the feed is deposited through the drop tube and feeder cone. So positioned to be situated within or atop the feed, the anti-scratch ring inhibits excessive motion or scooping of the feed by poultry to prevent feed wastage.

In the fifth embodiment feeder 500 of FIG. 6, a pair of laser light sources 502 is hung from each pair of diametrically opposing grill arms 60 to direct their beams downward into the feed pan 66 at positions between the feeder cone 64 and the outer annular wall 67 of the feed pan 66. Although only two laser light sources are visible in the figure, one is provided at each of the four arms of the grill assembly. Of course the number of laser light sources may be varied and need not necessarily be matched one to one with the number of grill arms, which may vary between different grill-equipped feeders. Each laser light source 502 provides a beam of focused light directed onto a respective fraction of the total feed present in the feed pan 66. The beam and the corresponding spot-like illumination of the feed are of significant contrast to the dimly lit surroundings of a conventional poultry barn, providing a bright focal point likely to attract the attention of poultry to the feeder. Flexibly hung, the laser light sources may move under the exertion of air currents or contact with the feeder from outside forces, such as bumping by the animals, which may result in more of a reaction from the poultry. With the grill assembly supported on the drop tube which in turn is supported on the delivery line, it should be appreciated that the light sources may be supported elsewhere on the delivery line or the drop tube to similarly illuminate a fraction of the feed in the feed pan with sufficient brightness to contrast with the darker surrounding environment and the remainder of the feed.

In the sixth embodiment feeder 600 of FIG. 7, instead of laser light sources hung from the grill arms 60, the anti-scratch ring 70 is equipped with a plurality of light-emitting diodes, or LEDs, 602 at spaced positions therealong. Supported on the anti-scratch ring, the LEDs are positioned to be located in or on the feed dispends into the feed pan 66 to provide high contrast illumination at spaced positions about the central axis of the feeder defined by the shared axis of the concentric feed pan 66, feeder cone 64 and grill assembly.

Each of the foregoing embodiments describes a feeding system for poultry featuring a feeding station having a feed holder arranged for supporting feed in a position accessible by the poultry, and a light source arranged for mounting at a position relative to the feeding station to illuminate the feed holder. In use, these systems each provide an amount of feed at a feeding location accessible by and visible to the poultry and direct illumination from a light source toward the feeding location to attract attention of the poultry to the feed and thereby increase feed consumption. Although the illustrated feeders are described above in the context of an automated feed delivery system using an auger-equipped delivery line to fill the feeders from a hopper containing a supply of feed, it should be appreciated that the apparatuses and methods of using light to attract the attention of poultry and increase feed consumption are not limited to such multi-station feeding system applications. It should also be appreciated that such apparatuses and methods may similarly be used with poultry other than turkeys, or even with other livestock, provided that such animals are found to similarly react to focused, high-intensity, or high-contrast application of light sources.

The systems of light or lights used to attract livestock to food, and thereby encourage them to eat more, may make use of various light sources, including LEDs; incandescent bulbs; fluorescent, neon or other tube lights; or natural sunlight. Various mounting brackets may be used to support lighting systems in or on various feeder types and shapes or at other locations to shine on the food. For example, the annular light sources described in some of the embodiments are not limited to circular rings, and thus can be used on feeders other than those having round feeder cones and feed pans. These other types of feeders include those arranged to provide water, liquid feed or solids, with lighting systems being mountable in a variety of environments near locations where feeding takes place. Mirrors, other reflective surfaces, light tubes, fiber optics or other systems can be used to direct the light. Lighting systems may be added to existing feeders by their owners or operators, or a feeder may be provided with the light system built in. The physical embodiments described above and illustrated in the figures are well-suited for the method used to encourage animals to eat, and to eat more.

As described above, a livestock feeder or part of a livestock feeder or an external light assembly characteristically uses light or lights to entice or attract poultry or other livestock to feed and/or water. The lights may be an integral part of the feeder, installed after-market, or be separate from the feeder altogether. These possibilities include lights in the feeder directed onto the feed, lights in the feed itself, lights attached to the feeder shining on the feed, or lights separate from the feeder shining onto the feed. For example, such an external system could include but not be limited to a laser system designed to shine on the feed, a fiber optic system whereby the lit ends of the fiber optic strands shine in the feed, or a light that shines from within the lip of the feeder cone or feed pan, lighting the feed below. Such a laser system may include a rotating or moving mirror or mirrors used to direct the light onto the feed in the feeder. As described above, integral systems may use a system of lights built into the cone of the feeder or the outer ring of the pan of the feeder. Systems may direct natural light (sunlight) onto the feeder, including but not limited to systems using mirrors, light tubes or tunnels used to direct sunlight into a building from above, bundled fiber optic strands extending onto or into the feeder, other reflective or refractive means, or direct exposure limited to the feeder and not its surroundings. The apparatuses and methods use a contrast in light, by shining a brighter light on or in the food to attract animals to eat, and eat more because they are attracted to bright lights and shiny or high-contrast things.

The illumination of the feed may be controlled manually, but a more preferable feeding system would implement automated lighting control. Such a controller would preferably allow feeder illumination to be turned on and off, and may have an input used to indicate whether the house lights in a barn type or other indoor livestock setting are on or off, and illuminate the feed accordingly. This way, the feeder illumination can be controlled so as not to turn on when the house lights are off, thereby avoiding possible spooking of the livestock during the night. Such an input may be provided by a light sensor, such as a photo-cell, or provided as a signal from an existing house light control. The input may be the electrical current used to power the house lights, which can be detected by the feed system controller.

As some existing house light systems include manual dimmers or control systems featuring dimming functions to allow control of light intensity within the barn, for example to allow adjustment of the level of house lighting from one stage of the livestock life cycle to another, the control may require special circuitry or electrical equipment to deal with house lights that have been dimmed. That is, the control may require digital voltage sensors, relays, or other equipment able to sense and react to a range of voltages that might be experienced during operation of dimmable house lights. If the electrical current from the house lighting system is being used directly as an input signal for the feed system lighting controller, then the voltage would be lower when the lights are dimmed. Alternatively, if a photocell is used to provide the input signal to the feed system lighting controller, then dimmed lights would produce a lower current in the photocell. The controller would need a relay, voltage sensor, or other equipment sensitive enough to detect the presence of lower voltages from the photocell or supply current when the house lights are still on, but dimmed. For example, use of a relay having an operating voltage range of 80 to 125-volts in a house lighting system having a conventional North American 110-volt power supply would not be ideal if the relay is installed between a house light and a dimming control for the house light that is operable to reduce the line voltage at this location to a level below 80 volts, but still sufficient to illuminate the house light at a dimmed level. The relay, being used to close the feed system lighting circuit to enable operation thereof when the house lights are on, would not be tripped when the house light is so dimmed, and the feeding system lights would thus not be activated. Therefore, when intended for use in the context of a barn or other enclosure equipped with a dimming house light system, the feed system lighting controller should use a house light detector arrangement sensitive to a wide range of control signals or voltages to allow particular feed system lighting actions to be taken depending on the house light status.

The control may be able to control the lights so that they are on for only a partial fraction of every hour, day, or another user-configurable time. The fraction of this time for which the feed system lights are on, and the position of this fraction within the overall time interval, are preferably user-configurable.

The control may be able to make the lights flash, in which case each of the following intervals during a flashing sequence may be user-configurable: a) the length of time the light is on and b) the length of time the light is off. Each of these intervals may also be configured as a random amount of time within a range of possible time periods to create a random flashing effect.

The control may also be able to store one or more “programs” that define how the lights are to behave at various times or under various conditions. The control may be programmed, configured or controlled to use different programs at different times in the life of the livestock or flock, for example to have the lights on a lot when the animals are young to encourage them to learn to eat, to have the lights on only for short periods when the animals are nearing market weight to prevent overeating and thereby reduce the occurrence of heart attacks, and to have the lights turn on and off regularly in the livestock ages in between so that feeding animals will lose interest and walk away when the lights go out, allowing others to notice the lights when they reactivate and accordingly approach the feeder and eat. The control may be programmed to turn the lights on for “meals” and “snacks” throughout the day, where a meal or snack is a selected time when the birds' or animals' feeding is to be stimulated.

The control may include equipment to control or regulate the voltage for electrically powered feeder illumination. The control may include power controlling equipment to control the brightness of the feeder illumination. This may include controlling the voltage, current, or utilizing a pulse-wave modulation method of simulating dimming of LED lights. The control may allow the user to configure the brightness of the light sources during various times in the program. The control may facilitate gradual turning of the light sources on or off, so that there is no sudden flash of light or lack of light that might spook or scare the birds or other livestock.

The control may include a dust and waterproof case and may utilize a programmable logic controller to implement some or all of the functions listed above. The control may be used to program and control multiple barns or poultry houses. The control may be able to store and name multiple programs that may be selected. The control may have a computer interface for ease of programming and may be installed separately from or integral with, for example as a component of or an addition to, a house lighting control system for a barn or other livestock feeding area.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of feeding livestock, the method comprising:
providing an amount of feed at a feeding location accessible by the livestock; and
directing illumination from a light source toward the feeding location accessible by the livestock to attract attention of the livestock to the feed.

2. The method according to claim 1 wherein the step of providing an amount of feed comprises providing the amount of feed in an environment darker than the illumination to create contrast therebetween.

3. The method according to claim 1 wherein the step of directing the illumination comprises directing the illumination over only a fraction of the amount of feed.

4. The method according to claim 1 wherein the step of directing the illumination comprises supporting the light source at an elevation above the amount of feed.

5. The method according to claim 1 wherein the step of directing the illumination comprises directing a beam of light toward the feeding location.

6. The method according to claim 1 wherein the step of directing the illumination comprises exposing a strip of light between the light source and the amount of feed.

7. The method according to claim 1 wherein the step of directing the illumination comprises directing the illumination onto the amount of feed.

8. The method according to claim 1 wherein the step of directing the illumination comprises supporting the light source on the amount of feed.

9. The method according to claim 1 wherein the step of directing the illumination comprises supporting an annular light source to extend about a central portion of the amount of feed.

10. A feeding system for livestock, the feeding system comprising:
a feeding station comprising a feed holder arranged for supporting feed in a position accessible by the livestock; and
a light source arranged for mounting at a position relative to the feeding station to illuminate the feed holder.

11. The feeding system according to claim 12 wherein the light source comprises a laser.

12. The feeding system according to claim 12 wherein the light source comprises a light-emitting diode.

13. The feeding system according to claim 12 wherein the light source comprises a fibre optic light source.

14. The feeding system according to claim 12 wherein the light source comprises an annular light source arranged for extending about an axis of the feed container.

15. The feeding system according to claim 12 wherein the light source is arranged for support on the feeding station above the bottom of the feed holder.

16. The feeding system according to claim 12 wherein the light source is arranged for support on a drop tube arranged to depend downward toward the bottom of feed holder to supply the feed thereto.

17. The feeding system according to claim 12 wherein the light source is supported on an anti-scratch ring arranged to extend around a feeder cone arranged to depend downward toward the bottom of feed holder to control supply of the feed thereto.

18. The feeding system according to claim 12 further comprising a feed delivery line coupled between a feed supply container and the feeding station to facilitate delivery of feed thereto, wherein the light source is arranged for support on the feed delivery line.

19. The feeding system according to claim 12 wherein the feed holder comprises a feed pan having an outer annular wall, the light source being arranged for support inward of the outer annular wall.

20. The feeding system according to claim 12 wherein the light source comprises a fibre optic cable arranged to extend into the feeding station to lie along the feed holder.
